(19) United States
(12) Patent Application Publication
(10) Pub. No.: US 2002/0112049 A1
(43) Pub. Date: Aug. 15, 2002

(54) Measuring response time for a computer accessing information from a network

(75) Inventors: Elmootazbellah Nabil Elnozahy, Austin, TX (US); Ramakrishnan Rajamony, Austin, TX (US)

Correspondence Address: International Business Machines Corporation, Intellectual Property Law Department, Internal Zip 4054, 11400 Burnet Road, Austin, TX, 78758, US

(73) Assignee: International Business Machines Corporation

(21) Appl. No.: 09/736,348

(22) Filed: Dec. 14, 2000

(51) Int. Cl. G06F 15/173; G06F 15/16

(52) U.S. Cl. 709/224; 709/203

(57) ABSTRACT

A method, computer program product and apparatus are disclosed for generating response time data for a client accessing information from a network. In one of the embodiments first instructions are attached to a first block of information. The block of information is available for requesting by the client from the network. The first instructions are for causing the client to read a first reference time, responsive to the client initiating access to a second block of information from the network. Second instructions are attached to the second block of information. The second instructions are for causing the client to read a second reference time responsive to the client loading the second block of information, and for causing the client to retrieve the first reference time and compute a time difference between the first and second reference times.

### CROSS REFERENCE TO RELATED APPLICATIONS

The present application is related to the below-named application which is filed on the same date as the present application and hereby incorporated herein by reference: “Verification of Service Level Agreement Contracts,” Ser. No. ______ (Applicant's docket number AUS9-2000-0521-US1). The two applications are commonly assigned.

### BACKGROUND OF THE INVENTION

1. Field of the Invention

This invention relates to performance of a server and network providing information to a client, and, more specifically, to measurement of the combined network and server performance, at least in part, by the client executing instructions included with the information to the client.

2. Description of the Related Art

Businesses increasingly use the World Wide Web (WWW) to supply information and perform services for their customers, such as news, stock quotes, movie reviews and driving directions. Customer satisfaction often depends greatly on responsive access to this information and these services. Network performance and server-side latency are two primary factors that contribute to response time experienced by a client system accessing information on the WWW. (“Server-side latency” refers to the time interval from the time a request reaches the web server until the time the server sends a response, and includes the time it takes the server to generate the response.)

It is therefore important that businesses have access to quantitative information about the perceived response time of their services. This information guides the reaction of the business if the performance is below expectations. There are many established techniques for reducing the response time over the Web, including the use of powerful servers, reverse proxies at the server, Web caches, and clever load balancing among clustered or geographically dispersed servers.

In the case of a business contracting with an Internet Data Center (IDC) to provide Web services, response time measurements serve to verify that the IDC is abiding by the Service Level Agreement (SLA) that defines the level of services and performance guarantees. The current state of the art is for a business to contract with a third party company to conduct periodic polling of its services, and thus generate an approximation of the response time perceived by actual customers. There are drawbacks to this polling scheme for several reasons, among which are accuracy, an increased load on the Web server due to the polling traffic, and difficulty of ensuring accurate or complete geographic coverage. Furthermore, some services may be cumbersome to measure by fictitious requests (e.g. financial transactions). An alternative to polling is to measure the server latency alone. IDC's provide this information to their customers, while “in-house” centers can measure the response time in a straightforward manner. This measurement, however, does not include the network interactions, and thus does not represent accurately the customer's perceived response time. For instance, such a measurement does not point to potential problems within the network (e.g. the need for faster Internet connection). Additionally, in the case of the IDC's, there has to be a mechanism for verifying the quoted numbers.

Therefore, a need exists for improvements in response time measurement, taking into account not only server-side latency, but also network performance, so that the response time measurement reflects latency experienced by a client system accessing information on the WWW.

### BRIEF SUMMARY OF THE INVENTION

The foregoing need is addressed in an apparatus and method for measuring performance of a server and network, specifically their combined performance in delivering information to a client. This measurement is obtained, at least in part, by the client executing instructions that are delivered to the client with the information.

In one embodiment, the client browses a first web page (or, more generally, a first “block of information”) that includes script, or at least a reference to script, executable by the client's browser program. Responsive to the client initiating a request for a second block of information to a web server, the client browser determines and records the current time, as a starting time, by executing the script. Conventional browser actions then cause the requested second block to be loaded on the client and, in addition, script elements associated with the second block are also loaded. After the response is fully received, the client again determines the now current time, as an ending time, and computes a response time. That is, the response time is computed as the difference between the ending time and the starting time previously recorded.

In another aspect, the first instructions are attached to a link in the first block of information. The link references the second block, so that the first instructions are capable of being executed by the client upon dereferencing the link.

Also, in a further aspect, the second block is for the client to display in a page frame of a window and the first instructions include instructions for causing the client to load the first reference time in a hidden frame of the window.

In another aspect, the first instructions are also attached to the second block of information, providing a second reference for the client to first instructions. The second reference to the first instructions is for causing the client to read a third reference time, responsive to the client initiating access to a third block of information from the network, and causing the client to load the third reference time in the hidden frame.

In alternative aspects, the first instructions include instructions for causing the client to store the first reference time in a cookie, or instructions for causing the client to open a window and store the first reference time in the window.

In yet a further aspect, the blocks of information are for the client to display in at least one window. In the first instructions are included “appending” instructions for causing the client to append the first reference time to a window name for one or the windows. In the second instructions are included “parsing” instructions for causing the client to parse the first reference time from the window name.

In another embodiment, a computer program product includes first instructions attached to a first block of information. The block of information is available for requesting by a client from a network. The first instructions are for causing the client to read a first reference time responsive to the client initiating access to a second block of information from the network. The computer program product also includes second instructions attached to the second block of information. The second instructions are for causing the client to read a second reference time responsive to the client loading the second block of information, and for causing the client to retrieve the first reference time and compute a time difference between the first and second reference times.

In another embodiment a server includes a storage device and a processor connected to the storage device and a network. The storage device is for storing: i) a program for controlling the processor, ii) blocks of information, iii) first instructions attached to a first one of the blocks of information, and iv) second instructions attached to a second one of the blocks of information. The blocks of information are available for requesting by a client via the network. The first instructions are for causing the client to read a first reference time responsive to the client initiating access to the second block of information from the network. The second instructions are for causing the client to read a second reference time responsive to the client loading the second block of information, and causing the client to retrieve the first reference time and compute a time difference between the first and second reference times.

It is an advantage of the present invention that performance is measured without imposing a substantial extra demand on the server or network. This is in contrast to the extra traffic generated by conventional polling methods for measuring performance. Further, it is applicable to any business, whether they run their services “in-house” or in a consolidated server.

It is another advantage that the invention works with existing technology restrictions and limitations In particular, it does not require any changes to conventional Hyper Text Transfer Protocol (HTTP) or browsers.

It is still another advantage that since both start and end times are computed on the client, no clock synchronization is required. These and other advantages of the invention will be further apparent from the following drawings and detailed description.

### BRIEF DESCRIPTION OF THE DRAWING

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 illustrates a client accessing web pages from a server, in accordance with an embodiment of the invention.

FIG. 2 illustrates accessing a bundle of web pages, in accordance with an embodiment of the invention.

FIG. 3 illustrates recording a time in a separate browser window, in accordance with an embodiment of the invention.

FIG. 4 illustrates recording a time in a frame of a browser window, in accordance with an embodiment of the invention.

FIG. 5 illustrates recording a time appended to the name of a browser window, in accordance with an embodiment of the invention.

FIG. 6 illustrates method steps for a first script, in accordance with an embodiment of the invention.

FIG. 7 illustrates method steps for a second script, in accordance with an embodiment of the invention.

FIG. 8 illustrates method steps for a third script, in accordance with an embodiment of the invention.

### DETAILED DESCRIPTION OF THE INVENTION

The following terminology and features of Hypertext Markup Language (“HTML”), version 4.01, are important to an understanding of the present embodiment.

An HTML page can contain embedded client-side scripts which are executed as the page is parsed by the browser. Alternatively, the scripts may be in a file or files separate from but referenced in the HTML page. (Script parsing can be deferred by a browser only if the “defer” attribute of the SCRIPT tag is set true. In its absence, scripts are parsed as they are encountered.) Furthermore, HTML link elements can contain a script snippet instead of a URL. When a link containing a script snippet is dereferenced, the script is executed.

The following paraphrases the HTML 4.01 standard:

A client-side script is a program that may accompany an HTML document or be embedded directly in it. The script executes on the client's machine. Authors may attach a script to a HTML document such that it gets executed every time a specific event occurs, such as, for example, when the user activates a link. Such scripts may be assigned to a number of elements via the intrinsic event attributes. Script support in HTML is independent of the scripting language.

Javascript is one example of a widely used scripting language that is supported by Netscape's Navigator and Microsoft's Internet Explorer browsers.

TML 4.01 also specifies several intrinsic events and the interfaces through which client-side scripts can be invoked when different events occur. Two specific events that can invoke a script attached to a document are:

onload( ): In the context of a document, the onload handler is triggered when a document and its embedded elements have been fully loaded. In addition, Javascript provides an onload handler for IMAGE objects that is triggered when the image has been fully loaded.

onunload( ): Triggered when a document is about to be unloaded to make room for a new document, or when the browser is being closed.

The following terms are specific to the present embodiment and are used herein.

A bundle is a set of web pages that have been instrumented to measure client-perceived response times. These may be HTML or non-HTML pages, and could be static files or dynamically generated content. The HTML pages in the bundle may contain links to each other, enabling users to traverse the bundle by dereferencing hyperlinks. There can be two kinds of links: instrumented and uninstrumented. An instrumented link points to a page whose response time we want to measure when the link is dereferenced. An uninstrumented link points to a page whose response time is not interesting.

Users arrive at a specific page within a bundle in one of two ways, causing it to be loaded in their browser. First, the user may have dereferenced an instrumented link from another page within the bundle. This an instrumented entry into the page. Alternatively, they may have directly entered the page's URL into the browser, or may have followed a link from a page not within the bundle. This is an outside entry into the page.

According to the present embodiment, a response time is determined for all instrumented entries to HTML pages in the bundle. Furthermore, the present embodiment also provides a scheme to determine the response time of all images contained within an HTML page. The embodiment includes i) a timekeeping aspect, which concerns reading time related data at certain instants and using the data to compute elapsed times, i.e., response time samples, and ii) a “librarian” aspect, which concerns storage and retreival of the data according to a well-defined interface. These actions are carried out using the above described HTML events and scripts. That is, timekeeping uses the two intrinsic HTML events, onload and onunload and the feature permitting a script to be invoked when a link is activated. Every web page in the instrumented bundle is set up such that a timekeeper script is invoked when a user clicks on a link.

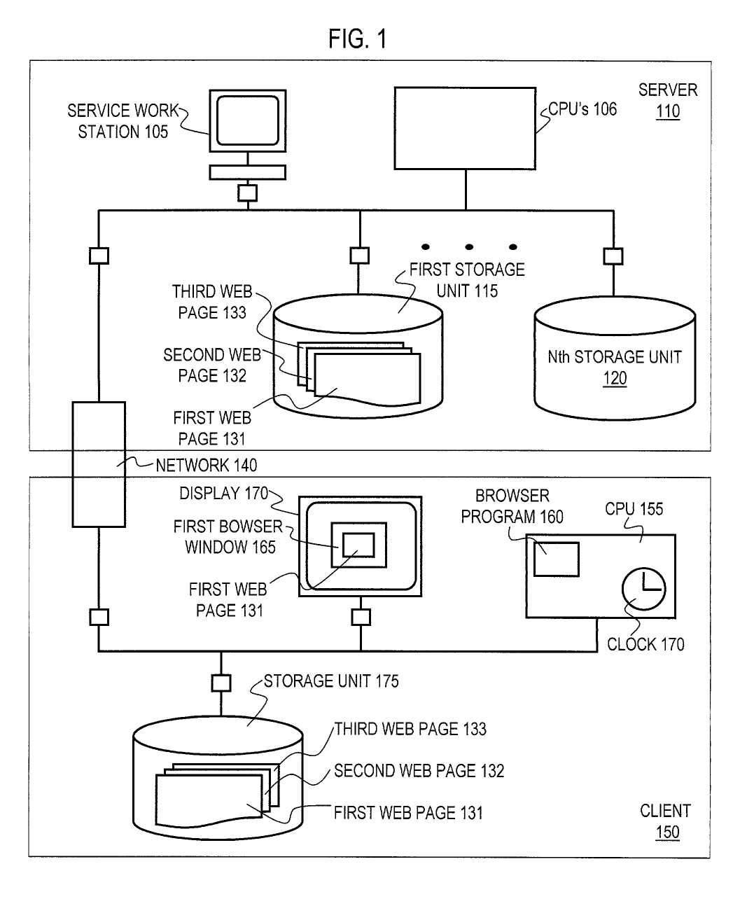

FIG. 1, illustrates aspects of an embodiment of the present invention in the context of the WWW, an open community of hypertext-enabled document servers and readers on the Internet. That is, client 150 is connected to a server 110 by a network 140, so that the client 150 can obtain hypertext documents, such as first, second and third web pages, 131, 132 and 133 respectively, from the server 110. In the example shown, the pages are stored by the server 110 in a first storage unit 115, and copies are delivered to the client's storage unit 175 The client 150 executes a browser program on its CPU 155, for generating images of the web pages on the client's display 170. For illustration, first web page 131 is shown in a first browser window 165 on display 170. Also shown is a clock 170 in CPU 155. A Javascript program executing in the browser program 160 is capable of reading the clock 170.

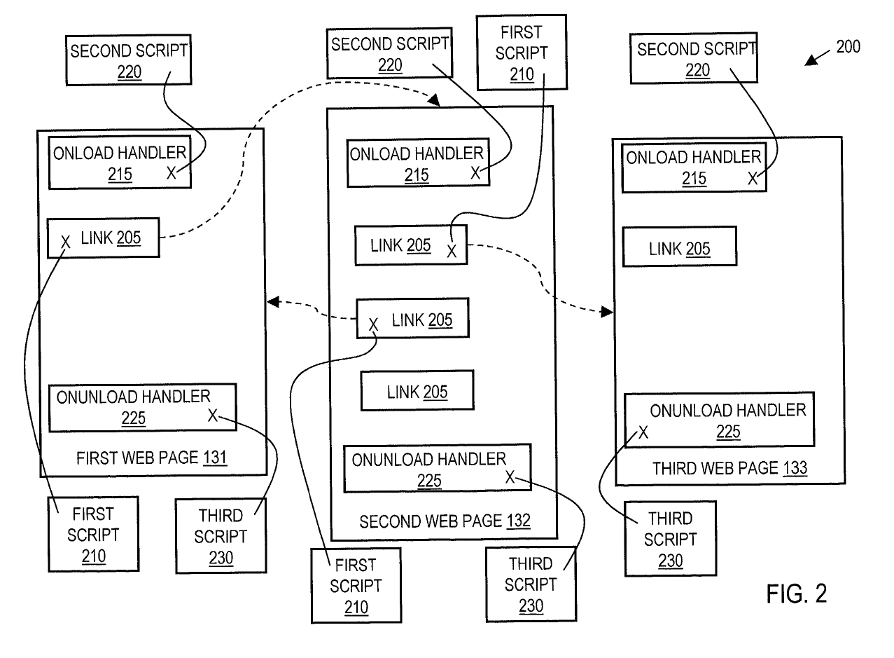

Referring now to FIG. 2, first, second and third web pages, 131, 132 and 133 are shown. These web pages are all part of the same bundle 200 of instrumented pages, and accordingly have included therein respective references to first, second and third scripts 210, 220 and 230 respectively. It should be understood that although numerous instances of the scripts 210, 220 and 230 are shown, this may be merely figurative. In a preferred embodiment, only one instance of each script actually exists for bundle 200. That is, the scripts may be in separate files stored on the server 110, and each one is delivered to the client the first time the client 150 receives a page which references the script. Moreover, it should be understood that the scripts may even be in one file. Herein, reference to first script 210, second script 220, etc. should be understood to include reference to a first function, second function, etc. where the functions may all be defined in a single script file.

In particular, an instrumented link 205 is shown on first web page 131, having a first script 210 attached. (Herein reference to a script “attached to” a page or a link, is meant to include both the case of the script itself being inserted in the page, and the case of a reference to the script being included in the page or link, so that while the script itself is not included in the page, the script is nevertheless called by the reference.) The link 205 in the first page 131 links the page 131 to the second web page 132. When a user clicks on the link 205 in web page 131, the browser program 160 (FIG. 1) begins executing the first script 210 for the web page 131 link 205. The script 210 directs the browser program 160 (FIG. 1) to determine the current time, record it as a “sendtime,” and then dereference the link 205, loading the second web page 132.

Likewise, each of the other pages 132 and 133 have links 205 to web pages. Each one of the links 205 that references one of the web pages in the bundle 200 has the first script 210 attached. Note that the third web page 133 has a link 205 which does not reference one of the pages in the bundle, so this link does not have the first script 210 attached. Note also, the second web page 132 has two links 205 that reference other pages in the bundle 200 and one link 205 that references a page not in the bundle 200, so page 132 has the first script 210 attached twice.

Since the page 132 is instrumented, a second script 220, is attached to the page as an onload handler for the page 132. (The script 220 may constitute the entire script for the handler 215, or it may be included with some other handler-related script, so reference may be made herein to the script 220 being “included in” or “attached to” the onload handler 215 to encompass both possibilities.) Following the user clicking on the link 205 in web page 131, and responsive to the second page 132 being fully loaded by the browser 160, the second script 220 for the page 132 begins executing. The script 220 directs the browser program 160 (FIG. 1) to get the current time, retrieve the sendtime, and calculate the response time, that is, the difference between the current time and the “sendtime”. (This second reference time is also referred to herein as an “end” or “ending” or “now” time.)

Likewise, each of the other pages 131 and 133 of the bundle is attached to second script 220 for its respective onload handler 215. In similar fashion, each of the pages 131 through 133 is attached to a third script 230 for its respective onunload handler 225. (The script 230 may constitute the entire script for the handler 225, or it may be included with some other handler-related script, so reference may be made herein to the script 230 being “included in” or “attached to” the onload handler 225 to encompass both possibilities.)

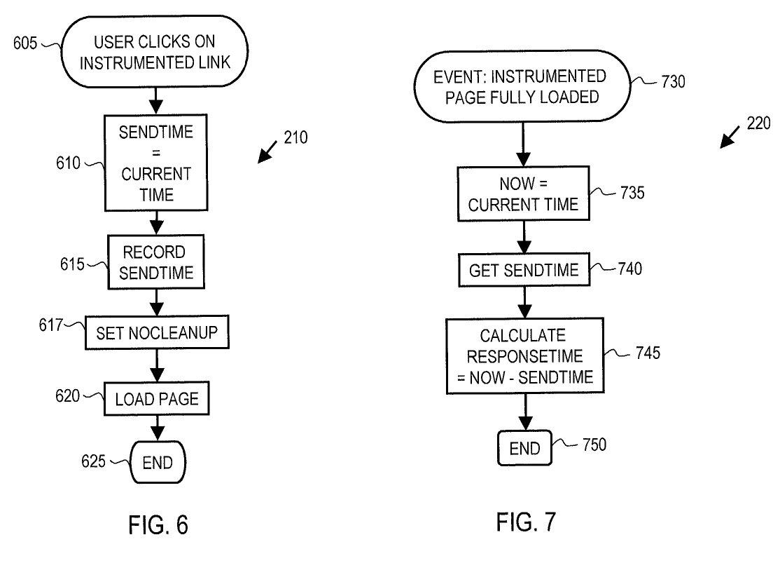

Referring now to FIG. 6, method steps are shown for the first script 210 associated with the links in each instrumented page to other pages in the bundle, according to the present embodiment. At 605 the browser program 160 (FIG. 1) begins running the script 210, responsive to the user initiating access to a second instrumented web page 132 (FIG. 2), by clicking on a link 205 (FIG. 2) in a first instrumented web page 131 (FIG. 2). At 610, under control of the browser program 160 (FIG. 1) running the script 210, the browser 160 obtains the current time from the client 150 clock 170 (FIG. 1), assigning the current time to variable “sendtime.” Next, at 615, the browser records “sendtime,” which will be explained in great detail hereinbelow in connection with librarian aspects of the embodiment. Next, at 617, the browser sets a variable “nocleanup.” This will be described hereinbelow in connection with unloading a web page. Then the browser loads the requested page at 620. The script 210 terminates at 625.

Referring now to FIG. 7, method steps are shown for the onload handler second script 220 for each instrumented page, according to the present embodiment. Responsive to the requested second page 132 fully loading, at 730, the second script 220 begins execution. The browser program 160, at 735, consequently obtains the current time from the client 150 clock 170 (FIG. 1), assigning the current time to variable “now.” Next, at 740, the browser retrieves “sendtime” (as will be explained in further detail hereinbelow), and then, at 745, calculates the response time for obtaining the requested page, that is the difference between “now” and “sendtime.” The second script 220 of the present embodiment ends at 750. At this point, further steps are performed, which may include saving the response time, and sending the response time.

Following the loading of second instrumented page 132 the page will eventually be unloaded, either by the user directing the browser to load another page or to close the browser window. If the instrumented page 132 is unloaded responsive to the user clicking on a link therein to another instrumented page, that is, an instrumented entry back to the first page 131 or to a third page 133 in the bundle, then, the browser begins executing the first script 210 again, this time associated with a link 205 in the second page 132. If the second page is unloaded due to the user typing a URL in the browser or closing the browser window, then steps described in the related patent application are performed.

An issue arises from different steps called for in response to unloading due to an instrumented entry versus otherwise unloading. That is, HTML specifications stipulate that if a currently loaded document has an unload event handler specified, that handler must be invoked before the new document is loaded. The unload handler is also invoked if the user closes the browser window. Since the unload handler is invoked when each document is displaced from the browser window, a distinction must be made between the onunload handler invocations on an instrumented entry to the next page, or on an outside entry to an arbitrary page that may be inside or outside the bundle.

This distinction is made in the present embodiment by including in the first script 210 instructions for setting the variable “cleanup” in the window object. See step 617 in FIG. 6. Accordingly, responsive to the user clicking on the link 205 in the first page 313, which initiates loading of the second page 132. The variable cleanup is set and then the variable is checked by third script 230 in the first page 131.

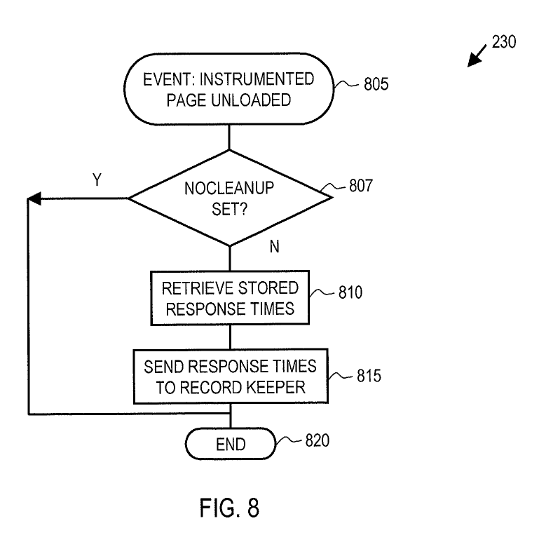

Referring now to FIG. 8, method steps are shown for the third script 230 included in onunload handlers in each instrumented page, according to the present embodiment. Responsive to the requested second page 132 unloading, at 805, the third script 230 begins execution. The browser program 160, at 807, checks whether variable cleanup is set in the window object. If it finds the variable set, this indicates that the current page is being displaced to make room for another instrumented page in the bundle, and no further processing is needed at this time of response times. However, if the variable is not set, steps 810 and 815 in the third script 230 associated with the related invention are performed to process one or more response times.

In the following, a number of alternatives are discussed for the librarian aspect of the present embodiment. This aspect is complicated by a limitation in browser programs regarding the storing of information. That is, to store and retrieve “sendtime” samples, as shown in steps 615 of FIG. 6 and 740 of FIG. 7, respectively, the browser must i) save a sendtime sample while a first page is loaded, ii) continue to save the sendtime sample while a second page is loading, and then iii) retrieve the sample after the page is fully loaded. However, for security purposes, Javascript has intentional limitations with respect to maintaining state across page loads. Consequently, there is no straightforward Javascript mechanism in a browser to maintain state across page loads. In particular, all of the scripts and variables associated with a page are cleared when a new document is loaded. In the alternative embodiments hereinbelow disclosed for the librarian aspect of the present embodiment, none require browser program modification.

In a first alternative, the librarian aspect of the present embodiment uses cookies. Simply stated, a cookie is a tag created by the server and delivered to the client along with an HTTP response. On subsequent requests to the same server, the client presents the tag it was given along with its request. Since HTTP, the protocol used for retrieving web pages, is inherently stateless, cookies were introduced as a mechanism to enable clients to build stateful sessions on top of this protocol. This permits a session to be built out of the individual HTTP transactions.

While it is a server that typically sets cookies, client-side scripts also have the ability to set, modify, and retrieve cookies. Thus, according to the cookie alternative for the present embodiment, a client-side Java script uses cookies to maintain state across page loads. That is, when a sendtime value needs to be recorded, client-side Javascript records the value in a cookie, and when the sendtime value needs to be retrieved, client-side Javascript code reads the cookie value.

This alternative has a drawback. The World Wide Web widely uses caches and proxies. The idea behind caching is to place an object “closer” to the browser, enabling a request to be serviced quickly and to reduce the demands placed by the request on both the network and the end web server. However, since cookies are used to create sessions out of HTTP transactions, a cache that observes a request with an attached cookie typically does not service the request. Instead, it forwards the request to the end web server. This is the correct approach since two requests for the same URI with different cookies could result in different responses. Using cookies for maintaining state therefore causes each request to be serviced by the end web server, tending to negate the usefulness of proxies and caches. Thus, this approach is practical only when the content being delivered is dynamic, with none of the intervening caches or proxies holding it.

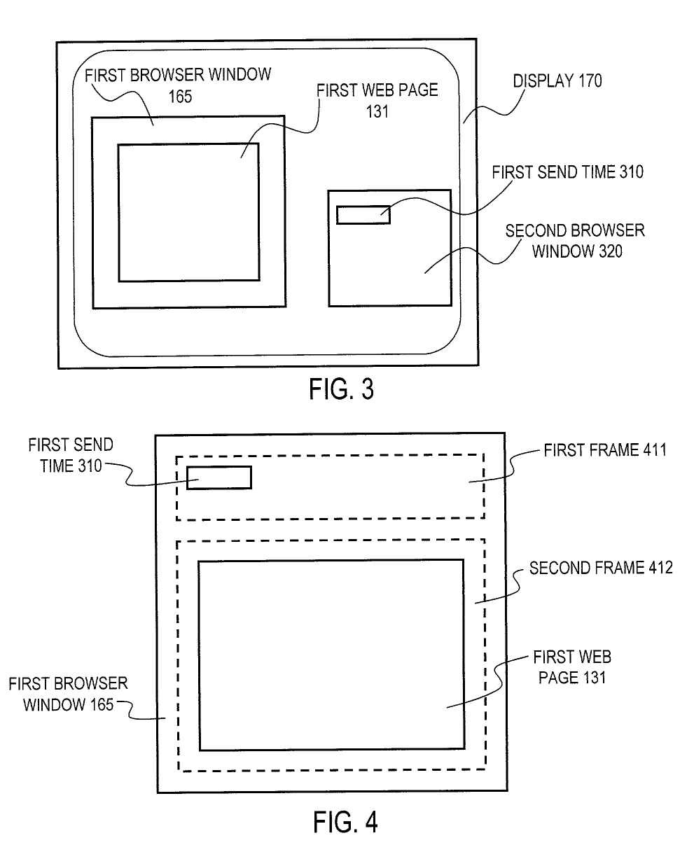

Another embodiment makes use of client-side Javascript to store state in a window object. Referring now to FIG. 3, a first browser window 165 is shown on the client system display 170, having first web page 131 displayed therein. A second window 320 is shown for the browser program 160 (FIG. 1), for saving sendtime in connection with replacing the first web page 131 with second web page 132. This second window 320 is opened by the browser 160 responsive to step 615 (FIG. 6). More specifically, function SetState ( ), shown below in Table One, is invoked by step 615 with a tag value that is unique to the window, such as the window name. Likewise, GetState ( ) is invoked by step 740 in FIG. 7. Thus, responsive to the initiation of the first instrumented entry to a web page, that is, when the user clicks on link 205 on the first page 131 causing the second page 132 to be loaded, the second window 320 is opened so that sendtime 310 may be saved there. For as long as this window stays open and until a different URL is loaded in it, state stored in its context can be recovered. Table One below shows Javascript code for this alternative.

TABLE ONE
Javascript code to save response time in a separate window

function OpenStateWindow()
{
// Get the state window object or open a blank window if it is not open
var h = self.open (“”, “statewin”, “width=100, height=100,
location=no”);
if (h.valid == null)// If the state window was just opened
{
h.valid = true;
h.document.write (“Please leave this window open”);
h.document.close();// Write a benign message in the window
}
return h;
}
function SetState (tag, value)
{
var handle = OpenStateWindow();
handle.tag = value;// The tag is supplied by the caller
}
function GetState (tag)
{
var h = OpenStateWindow ();
return h.tag;// undefined if tag does not exist
}

A disadvantage of this approach is the presence of the second window on the user's desktop. Even though this window can be small and can be made to contain a benign message, a user may arbitrarily close the window. Furthermore, although the window could be opened in a minimized state, doing so requires the script to obtain the UniversalBrowserWrite access privilege. JavaScript security restrictions prevent a script from opening a window in a minimized state, or with a size smaller than a prescribed minimum, unless the script has this privilege. While this privilege can be obtained by involving the user, its use may be considered intrusive.

Another alternative makes use of client-side Javascript to associate a second window object (described below) with the first browser window 165, instead of opening a second browser window 320. That is, each HTML frame (described below) within a browser window corresponds to a separate window object. This correspondence enables saving state in a frame within the same browser window as that displaying the document being loaded by the user.

In client-side Javascript, the window object is the global object and execution context. There is no direct correlation between a window as viewed in the desktop environment, and the window object. A window object is created for each desktop-level window or frame within a browser desktop window that displays a HTML document. From our perspective, the interesting property of client-side Javascript is that it permits scripts executing in one window object to access variables and scripts executing in another window object.

The HTML 4.01 standard describes frames as follows, permitting frames to be created with zero size (being invisible to the user):

HTML frames allow authors to present documents in multiple views, which may be independent windows or subwindows. Multiple views offer designers a way to keep certain information visible, while other views are scrolled or replaced. For example, within the same window, one frame might display a static banner, a second a navigation menu, and a third the main document that can be scrolled through or replaced by navigating in the second frame.

Referring now to FIG. 4, according to this embodiment each instrumented web page, such as first web page 131, has a corresponding frameset document. The frameset document definition in the page causes the browser to divide the top-level browser window 165 into two frames, responsive to loading the instrumented page 131. As shown in FIG. 4, first frame 411 (also referred to herein as a “hidden frame”) is used to save sendtime 310, and the second frame 412 (also referred to herein as a “page frame”) is for displaying the web page 131. The first frame is set to zero size and is therefore not visible to the user.

Saving of sendtime for this frame set alternative is accomplished in similar fashion as in the embodiment using the separate window. Table Two below lists Javascript for this frameset embodiment, showing how the timekeeping and library aspects interact together to determine the response time values.

TABLE TWO
Javascript code to save response time in separate frame

When user clicks on link:
var now = new Date();
top.RTFrame.sendtime = now.getTime();
location.href = [link location]
When document fully loaded:
if (top.frames.length == 0 || top.frames[0].name != “RTFrame”)
top.location = [corresponding frameset page];
else
{
now = new Date ();
delta = now.getTime () - top.RTFrame.sendtime;
[send delta to record keeper]
}

The existence of the hidden frame 411 gives rise to an issue. That is, there are two ways a user can make an uninstrumented entry to a page in the bundle. One of the ways poses no difficulty for the hidden frame, but the other is problematic. In the first way, the URL of the frameset document itself is dereferenced. This will cause both frame 411 and frame 412 to be loaded within the browser, and therefore poses no difficulty. But, if the URL of the second frame 412 alone is dereferenced, something must be done to the browser to ensure that the first frame 411 is also preserved.

In order to save state, this embodiment using separate frames requires the existence of frame 411 in addition to frame 412. Thus, when an uninstrumented entry loads frame 412 without frame 411, corrective action must be taken. To force the browser to load the corresponding frameset document, each instrumented page in the bundle contains Javascript to check for the existence of the response-time frame. Once the main frame has loaded, the existence check is made by the browser in response to instructions in the second script 220 included in the onload handler. If the response time frame does not exist, the Javascript forces the frameset document to be loaded in the top-level browser window.

According to this embodiment, visiting the instrumented site through a browser window causes the following actions to take place. On the first outside entry to an instrumented page, the Javascript actions of Table Two cause the corresponding frameset document to be loaded. As long as the user makes instrumented entries to the other pages in the bundle, the hidden, response time frame 411 stays in the browser window. This hidden frame needs to be reloaded only if the user makes an uninstrumented entry to a page in the bundle.

The main limitation of this frameset alternative is that the frameset document must be loaded on uninstrumented entries to the pages in the bundle. When encountering a page with frames, the browser first obtains the “container” frameset document. Only after receiving the container frameset can the browser determine what documents to obtain and render in the internal frames. This could give rise to extra client-server transactions and delays for the user.

Two factors mitigate the problem caused by the frameset document. First, the extra client-server transactions with its delay are encountered only during the initial uninstrumented entry to a web page. Subsequent instrumented browsing occurs at full speed. Furthermore, it may be possible to avoid the extra transactions by setting a long lifetime for the frameset documents. The Hypertext Transfer Protocol (HTTP) permits content to be delivered with explicit expiration times. This allows any intervening caches and the end client to cache content and use it without checking for validity against the origin web server. Providing the frameset document with a long lifetime makes it necessary for the browser to go and fetch the container frameset only when it is not present in the local browser cache. Consequently, when the user revisits a bundle at periodic intervals, the browser will be able to use a cached copy of the frameset document requiring only the data frame 412 document to be fetched. Such activities include getting the daily news, weather, sports scores, or performing banking or stock transactions.

Hereinabove, reference has been made to the window object in client-side Javascript. Every window object has a name property. This property exists so that it may be used as the value of a HTML TARGET attribute in the <A> or <FORM> tags. In essence, the TARGET attribute enables an anchor or frame to display its results (when the linked document is dereferenced or a form is submitted) in the window with the specified name.

The initial window and all new browser windows opened by Internet Explorer and Netscape Navigator have no predefined name attribute. Consequently, these windows cannot be addressed with a TARGET attribute. The name attribute is read-only in Javascript 1.0, creating a problem when the initial window has to be addressed. Javascript 1.1 resolves this problem by enabling the name attribute to be modified from within a script.

As previously stated, when a new page is loaded in a window, all of the scripts and variables associated with the window object are cleared. However, a window's name property persists across page loads. This enables a window with a newly loaded page to continue being the target of subsequent page loads. A popular use of this feature is to display help information in a special popup browser window.

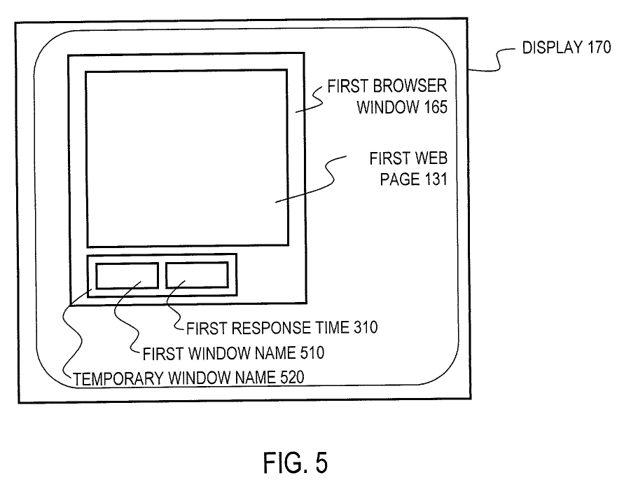

FIG. 5 illustrates how the persistence of the window.name property is used in the next alternative embodiment to store the sendtime values. The first browser window 165 is shown on display 170. The browser window 165 displays the first web page 131. A temporary window name 520 is shown assigned to the browser window 165. The temporary window name 520 includes the window name 510 for the first browser window 165 with the sendtime 310 appended thereto. The temporary window name 520 is created by the browser for recording sendtime, responsive to first instructions 210 in connection with loading a new page, as indicated in FIG. 6, step 615. Then, sendtime is retrieved by parsing sendtime from the temporary window name 520, responsive to second script in step 740, in FIG. 7. In connection with the parsing of sendtime from the temporary name 520, the first window name 510 is restored.

Table Three below sets out Javascript for the window naming alternative. It is worth noting that empirical tests with both Netscape Navigator and Internet Explorer demonstrate that both browsers support window names of sufficient length to permit this alternative.

TABLE THREE
Javascript code to append response time to “Window Name”

// Restrictions: value must not contain delimiter
//window.name must not contain delimiter
// Delimiter: The double underscore in this example
function AppendState (value)
{
self.name = self.name + “_” + value;// delimiter = double underscore
}
function GetState ()
{
var a = self.name.split(“_”);// split on double underscore
self.name = a[0];
if (a.length == 2)// Was the split successful?
return a[1];// Yes, split was successful
else
return (void 0);// No, so return undefined
}

A limitation of this alternative concerns a certain hazard it introduces. That is, according to this window name alternative, there is an interval when the window cannot be referred to by its name. The interval begins when the name is changed just prior to a second web page being loaded in the window, and ends when the saved state has been retrieved and the window name restored, that is, when the document has fully loaded. If the first web page has a structure according to which it persists in the first window and a second window pops up for the second web page, and the name being changed is associated with the pop-up window, then during this interval while the second page is being loaded, if the user clicks on another link in the first web page which, according to the design of the first web page, would load an alternative web page into the second, i.e., pop-up, window, then the hazard arises, wherein a third window would pop-up instead.

The hazard arises partly due to the awkward interface provided by client-side Javascript for referring to a window. The window.open( ) method is the only way to obtain a reference to an existing window using only its name. The name supplied must be exact, with no wild cards allowed. Furthermore, if a window with the supplied exact name does not exist, the method simply opens a new window with that name. The unexpected opening of a window arising from this hazard may be distracting to the user.

According to yet another alternative, which does not suffer from the above limitations, the windows in which the instrumented pages will be displayed are divided into the main windows and the child windows. The main windows are the set of windows that are not a target for any content. The child windows are those that are the target of content displayed from the main and child windows. For a page that is loaded in a main window, the librarian saves state in that window's name. For a page that is loaded in a child window, the librarian saves state in the main window that is the child window's ancestor. The ancestor can be determined by following the opener property of the child window, which is a reference to the window object that opened the child window. State saving and retrieving for this alternative are more complicated than that discussed hereinabove for the window name alternative, because sendtime must be saved and restored with tag values. However, it is totally safe to leave a main window's name in the changed state, since by definition, a main window can never be the target for any content display.

Up to this point, several embodiments have been described for determining the response time of instrumented entries to HTML pages in a bundle. In the following, an embodiment is described to determine the response times for displaying any included image in an instrumented page irrespective of whether it is loaded through an instrumented or outside entry. The HTML 4.0 standard requires that in the absence of a DEFER attribute, script execution must be carried out as a web page is being parsed. This requirement is used as follows. A script snippet is added to the HTML page just prior to the code loading the image. This snippet determines the sendtime and saves it in a variable in the current window object. The image is provided with an onload handler that determines the time when the image is fully loaded. The difference between the time the image is fully loaded and the sendtime yields the response time. The image is loaded in the same window object as the one in whose context the script snippet was executed. Hence, the onload handler can retrieve the sendtime by directly accessing the saved variable. Table 4 illustrates these actions. In table 4, “rt” is the computed response time and is transmitted in accordance with the related patent application.

TABLE FOUR
Javascript code for determining a response time for
displaying an image

The following code in an uninstrumented page:

< IMG src = “foo.jpg” >

is changed to

< SCRIPT language = “Javascript” >
var now = new Date ();
self.sendtime_foo = now.getTime ();
< / SCRIPT >
< IMG scr = “foo.jpg” onload = Javascript:: var now = new Date ();
rt = now.getTime () - self.sendtime_foo”>

The description of the present embodiment has been presented for purposes of illustration and description, but is not intended to be exhaustive or to limit the invention to the form disclosed. Many modifications and variations will be apparent to those of ordinary skill in the art. For example, the invention leverages scripting and event notification mechanisms in HTML 4.0 and Javascript 1.1 to measure and collect response time experienced by a client. HTML 4.0 and Javascript 1.1 are supported by both Netscape Navigator 3.x and above, and Internet Explorer 4.x and above, both of which are now fairly the de facto standard browsers. Microsoft's implementation of Javascript is officially known as JScript, and can be considered to be the same as Javascript for the purposes herein. The invention is not limited to these embodiments, and is equally applicable to embodiments with other scripting languages such as Visual Basic or Tcl, or to embodiments with Java or cookies. An advantage of implementing the invention with Javascript, as opposed to Java or cookies, is that support for either Java or cookies may be disabled by users.

Furthermore, it should be understood that a response time may be determined for each individual image within a web page. Also, the timekeeping can include associating the identity of each instrumented page or image along with the corresponding response time sample.

The embodiment was chosen and described in order to best explain the principles of the invention, the practical application, and to enable others of ordinary skill in the art to understand the invention. Various other embodiments having various modifications may be suited to a particular use contemplated, but may be within the scope of the present invention.

What is claimed is:

1. A method for generating response time data for a client accessing information from a network, comprising the steps of:
providing first instructions attached to a first block of information, wherein the block of information is available for requesting by a client from a network, and the first instructions are for causing the client to read a first reference time, responsive to the client initiating access to a second block of information from the network; and
providing second instructions attached to the second block of information, wherein the second instructions are for causing the client to read a second reference time responsive to the client loading the second block of information, and for causing the client to retrieve the first reference time and compute a time difference between the first and second reference times.

2. The method of claim 1, wherein the first instructions are attached to a link in the first block of information, wherein the link references the second block of information, so that the first instructions are capable of being executed by the client upon loading information indicated by the link.

3. The method of claim 1, wherein the second block of information is for the client to display in a page frame of a window and the first instructions include instructions for causing the client to load the first reference time in a hidden frame of the window.

4. The method of claim 3, wherein the second instructions include instructions for causing the client to read the first reference time in the hidden frame of the window.

5. The method of claim 2, wherein the second block of information is for the client to display in a page frame of a window and the first instructions include instructions for causing the client to load the first reference time in a hidden frame of the window.

6. The method of claim 5, wherein the second instructions include instructions for causing the client to read the first reference time in the hidden frame of the window.

7. The method of claim 6, comprising the step of:
providing a second reference to first instructions for the client, by the first instructions being also attached to the second block of information, wherein the second reference to the first instructions is for causing the client to read a third reference time, responsive to the client initiating access to a third block of information from the network, and causing the client to load the third reference time in the hidden fame.

8. The method of claim 1, wherein the first instructions include instructions for causing the client to store the first reference time in a cookie.

9. The method of claim 8, wherein the second instructions include instructions for causing the client to read the first reference time in the cookie.

10. The method of claim 1, wherein the first instructions include instructions for causing the client to open a window and store the first reference time in the window.

11. The method of claim 10, wherein the second instructions include instructions for causing the client to read the first reference time in the window.

12. The method of claim 1, wherein the blocks of information are for the client to display in at least one window, and wherein such a window has a window name, the method comprising the step of:
providing, in the first instructions, instructions for causing the client to append the first reference time to one of the window names.

13. The method of claim 12, comprising the step of:
providing, in the second instructions, instructions for causing the client to parse the first reference time from the window name.

14. The method of claim 2, wherein the blocks of information are for the client to display in at least one window, and wherein such a window has a window name, the method comprising the step of:
providing, in the first instructions, appending instructions for causing the client to append the first reference time to one of the window names.

15. The method of claim 14, comprising the step of:
providing, in the second instructions, parsing instructions for causing the client to parse the first reference time from the window name.

16. The method of claim 15, comprising the step of:
providing a second reference to first instructions for the client, by the first instructions being also attached to the second block of information, wherein the second reference to the first instructions is for causing the client to read a third reference time, responsive to the client initiating access to a third block of information from the network, and causing the client to append the third reference time to one of the window names.

17. A computer program product for generating response time data for a client accessing blocks of information from a network, the client program product comprising:
first instructions attached to a first block of information, wherein the block of information is available for requesting by a client from a network, and the first instructions are for causing the client to read a first reference time responsive to the client initiating access to a second block of information from the network; and
second instructions attached to the second block of information, wherein the second instructions are for causing the client to read a second reference time responsive to the client loading the second block of information, and for causing the client to retrieve the first reference time and compute a time difference between the first and second reference times.

18. The computer program product of claim 17, wherein the first instructions are attached to a link in the first block of information, wherein the link references the second block of information, so that the first instructions are capable of being executed by the client upon loading information indicated by the link.

19. The computer program product of claim 17, wherein the second block of information is for the client to display in a page frame of a window and the first instructions include instructions for causing the client to load the first reference time in a hidden frame of the window.

20. The computer program product of claim 19, wherein the second instructions include instructions for causing the client to read the first reference time in the hidden frame of the window.

21. The computer program product of claim 18, wherein the second block of information is for the client to display in a page frame of a window and the first instructions include instructions for causing the client to load the first reference time in a hidden frame of the window.

22. The computer program product of claim 21, wherein the second instructions include instructions for causing the client to read the first reference time in the hidden frame of the window.

23. The computer program product of claim 22, wherein the first instructions are also attached to the second block of information, so that responsive to the client initiating access from the second block of information to a third block of information, the first instructions are capable of a second instance of execution for causing the client to read a third reference time and to load the third reference time in the hidden frame.

24. The computer program product of claim 17, wherein the first instructions include instructions for causing the client to store the first reference time in a cookie.

25. The computer program product of claim 17, wherein the second instructions include instructions for causing the client to read the first reference time in the cookie.

26. The computer program product of claim 17, wherein the first instructions include instructions for causing the client to open a window and store the first reference time in the window.

27. The computer program product of claim 26, wherein the first instructions include instructions for causing the client to read the first reference time in the window.

28. The computer program product of claim 17, wherein the blocks of information are for the client to display in at least one window, such a window having a window name, and wherein the first instructions include instructions for causing the client to append the first reference time to one of the window names.

29. The computer program porduct of claim 28, wherein the second instructions include instructions for causing the client to parse the first reference time from the window name.

30. The computer program product of claim 18, wherein the blocks of information are for the client to display in at least one window, such a window having a window name, and wherein the first instructions include instructions for causing the client to append the first reference time to one of the window names.

31. The computer program porduct of claim 30, wherein the second instructions include instructions for causing the client to parse the first reference time from the window name.

32. The computer program product of claim 31, wherein the first instructions are also attached to the second block of information, so that responsive to the client initiating access from the second block of information to a third block of information, the first instructions are capable of a second instance of execution for causing the client to read a third reference time and append the third reference time to one of the window names.

33. A server comprising:
a processor for connecting to a network;
a storage device coupled to the processor, wherein the storage device is for storing:
a program for controlling the processor,
blocks of information,
first instructions attached to a first one of the blocks of information, and
second instructions attached to a second one of the blocks of information;
wherein the blocks of information are available for requesting by a client via the network, and the first instructions are for causing the client to read a first reference time responsive to the client initiating access to the second block of information from the network, and the second instructions are for causing the client to read a second reference time responsive to the client loading the second block of information, and causing the client to retrieve the first reference time and compute a time difference between the first and second reference times.

34. The server of claim 33, wherein the first instructions are attached to a link in the first block of information, wherein the link references the second block of information, so that the first instructions are capable of being executed by the client upon loading information indicated by the link.

35. The server of claim 33, wherein the second block of information is for the client to display in a page frame of a window and the first instructions include instructions for causing the client to load the first reference time in a hidden frame of the window.

36. The server of claim 35, wherein the second instructions include instructions for causing the client to read the first reference time in the hidden frame of the window.

37. The server of claim 34, wherein the second block of information is for the client to display in a page frame of a window and the first instructions include instructions for causing the client to load the first reference time in a hidden frame of the window.

38. The server of claim 37, wherein the second instructions include instructions for causing the client to read the first reference time in the hidden frame of the window.

39. The server of claim 38, wherein the first instructions are also attached to the second block of information, so that responsive to the client initiating access from the second block of information to a third block of information, the first instructions are capable of a second instance of execution for causing the client to read a third reference time and to load the third reference time in the hidden frame.

40. The server of claim 33, wherein the first instructions include instructions for causing the client to store the first reference time in a cookie.

41. The server of claim 40, wherein the second instructions include instructions for causing the client to read the first reference time in the cookie.

42. The server of claim 33, wherein the first instructions include instructions for causing the client to open a window and store the first reference time in the window.

43. The server of claim 42, wherein the second instructions include instructions for causing the client to read the first reference time in the window.

44. The server of claim 33, wherein the blocks of information are for the client to display in at least one window, such a window having a window name, and wherein the first instructions include instructions for causing the client to append the first reference time to one of the window names.

45. The server of claim 44, wherein the second instructions include instructions for causing the client to parse the first reference time from the window name.

46. The server of claim 34, wherein the blocks of information are for the client to display in at least one window, such a window having a window name, and wherein the first instructions include instructions for causing the client to append the first reference time to one of the window names.

47. The server of claim 46, wherein the second instructions include instructions for causing the client to parse the first reference time from the window name.

48. The server of claim 47, wherein the first instructions are also attached to the second block of information, so that responsive to the client initiating access from the second block of information to a third block of information, the first instructions are capable of a second instance of execution for causing the client to read a third reference time and to append the third reference time to one of the window names.
